(19) United States
(12) Patent Application Publication
(10) Pub. No.: US 2002/0163439 A1
(43) Pub. Date: Nov. 7, 2002

(54) METHOD OF TRANSMITTING A COMMAND FROM A REMOTE CONTROLLER TO AN AUDIO DEVICE, AND CORRESPONDING REMOTE CONTROLLER AND AUDIO DEVICE

(76) Inventors: LUC ATTIMONT, LE PORT MARLY (FR); JANNICK BODIN, GARCHES (FR)

Correspondence Address: SUGHRUE MION ZINN MACPEAK & SEAS, SUITE 800, 2100 PENNSYLVANIA AVENUE NW, WASHINGTON, DC, 200373213

(21) Appl. No.: 09/252,981

(22) Filed: Feb. 19, 1999

(30) Foreign Application Priority Data
Mar. 9, 1998 (FR) 98 02823

(51) Int. Cl. H04Q 1/00

(52) U.S. Cl. 340/825.25

(57) ABSTRACT

A remote controller transmits a command to an audio device. The audio device exchanges at least one audio signal with an audio accessory via a medium. The remote controller exchanges at least one control signal in which the command is encoded with the audio device. The control signal(s) are generated in a non-audio frequency band and superposed on the audio signal(s) on the medium. The remote controller encodes the command in the control signal(s) and the audio device decodes the command encoded in the control signal(s).

### BACKGROUND OF THE INVENTION

1. Field of the invention

The invention concerns the transmission of a command from a remote controller to an audio device provided with at least one audio accessory. The invention also concerns the remote controller and the audio device for implementing such transmission.

The present invention applies in particular, although not exclusively, to remote controlling a mobile radio communication terminal or a personal stereo (radio and/or cassette and/or compact disc) where the audio accessory is a headset comprising at least one earpiece and/or at least one microphone.

2. Description of the prior art

The benefit of a remote controller of the above kind is that it enables a user to control an audio device that is not readily accessible (for example because it is in a bag or in a pocket).

Generally speaking, there are two types of signal exchange: exchange of one or more audio signals between the audio device and the audio accessory, and exchange of one or more control signals between the remote controller and the audio device.

Conventionally, in the audio device, each command contained in (i.e. encoded in) a control signal is, after the control signal is received and processed, supplied to a processor that controls execution of commands.

Each command represents a choice made by the user (for example using one or more keys on the remote controller) to modify the operation of the audio device. It may be, for example, a command to adjust the sound volume (up/down), to change playback direction (forward/reverse), to scroll through a menu (up/down), to stop or to pause playback (stop/pause), to “answer” an incoming call (or to take the call) when the telephone rings, to “hang up” (or to terminate the call), etc. Clearly the above list is by no means exhaustive.

Audio signals are conventionally exchanged between the audio device and the audio accessory on a first medium.

For example, in the case of a personal stereo (cassette and/or otherwise) with headphones, the first medium interconnecting the two units comprises a ground wire and one or more audio wires. The ground and audio wires are usually grouped together in the same cable. Thus stereo headphones are generally connected to the personal stereo by a cable comprising two audio wires in addition to the ground wire and respectively connected to the left and right earpieces of the headphones. Similarly, in the case of a cordless telephone, the monophonic headset with microphone is connected to the cordless telephone by a cable comprising two audio wires in addition to the ground wire respectively connected to the earpieces and the microphone of the headset, both earpieces being connected to the same audio wire.

Exchange of control signals from the remote controller to the audio device is conventionally effected on a second medium separate from the first medium.

Thus, in the previously mentioned case of a cassette personal stereo with headphones, the remote controller is generally connected to the audio device by a second medium comprising one or more control wires separate from the ground wire and the audio wire(s). Each control wire is used to transmit one or more particular types of command.

In practice, for reasons of ease of use, the control wire(s) (constituting the second medium) are generally in the same cable as the ground wire and the audio wire(s) (constituting the first medium). Also, the remote controller is generally between the audio device and the audio accessory.

In other words, a single cable generally comprises two successive sections, namely:

a first section between the audio device and the remote controller and comprising the ground wire, the audio wire(s) and the control wire(s); and

a second section between the remote controller and the audio accessory and comprising only the ground wire and the audio wire(s).

Also, the cable is generally connected to the audio device by one or more first connectors having a total of M connections (or connecting pins) where: M=X+Y+1 where X is the number of audio wires, Y is the number of control wires and 1 represents the ground wire. Each (male or female) first connector is adapted to cooperate with a (female or male) second connector on one face of the audio device.

To be more precise, the following connecting members are conventionally employed (at the end of the cable and symmetrically on the surface of the audio device):

either a combination of a standard jack with X+1 connections (which is thus used only for the audio wire(s) and the ground wire) and an ancillary non-standard connector with Y connections (which is thus used only for the control wire(s));

or a single non-standard connector with M connections (possibly incorporating a standard jack with X+1 connections).

Unfortunately the current solution previously referred to, based on the use of separate first and second media, has a number of drawbacks.

First of all, the production of two separate media requires the use of a relatively large number of resources and equipments. Thus in the example referred to above the cable combining the first and second media comprises a large number of wires (namely M=X+Y+1).

What is more, as explained above, this large number of wires prevents the use at the end of the cable and on the surface of the audio device of a single standard jack (i.e. provided only for the ground wire and the audio wire or the X audio wires). In other words, this implies the use either of a non-standard ancillary connector (for the control wire(s)) in combination with the standard jack or a single non-standard connector with M connections (for all the wires).

In both cases the non-standard part of the connection (ancillary connector or single connector) increases the cost of manufacturing the connector as a whole.

What is more, because the number of connecting pins is high the fragility of the connection and the area reserved for the associated connector on the audio device are both increased.

An object of the invention is to alleviate the various drawbacks of the prior art.

To be more precise, one object of the present invention is to enable the transmission of a command from a remote controller to an audio device in a manner that reduces the quantity of resources and equipment (for example the number of wires) needed.

Another object of the invention, in the situation in which the first medium comprises a ground wire and X audio wire(s) grouped together in a cable, is to enable the use at the end of the cable and on the surface of the audio device of a single standard jack (i.e. one designed only for the ground wire and the X audio wire(s)).

### SUMMARY OF THE INVENTION

The above objects, and others that will become apparent hereinafter, are achieved in accordance with the invention with the aid of a method for transmitting a command from a remote controller to an audio device exchanging at least one audio signal with an audio accessory via a medium, the remote controller exchanging at least one control signal in which the command is encoded with the audio device, the method comprising the following steps: generating the at least one control signal in a non-audio frequency band separate from an audio frequency band in which the at least one audio signal is located, and superposing the at least one control signal and the at least one audio signal on the medium.

The general principle of the invention therefore consists in frequency multiplexing the audio signal(s) and the control signal(s) on a single medium. To enable such frequency multiplexing the invention requires the control signal(s) to be in a frequency band outside the audio band.

Thus, in contrast to the prior art solution (discussed hereinabove), the present invention does not necessitate any second medium between the audio device and the remote controller. In the prior art the audio signal(s) are transmitted on a first medium and the control signal(s) are transmitted on a second medium.

The invention also concerns a remote controller for an audio device exchanging at least one audio signal with an audio accessory via a medium, the remote controller exchanging at least one control signal in which the command is encoded with the audio device, wherein the at least one control signal is in a non-audio frequency band separate from an audio frequency band in which the at least one audio signal is located and superposed on the at least one audio signal on the medium and the remote controller comprises means for encoding the command in the at least one control signal.

Clearly the encoding means can allow the encoding of a plurality of different commands, offering the user many possibilities of modifying the operation of the audio device (for example adjusting the volume, changing from one playback direction to another, scrolling through a menu, stopping or pausing playback, answering an incoming call, hanging up at the end of a call, etc).

In a first particular embodiment of the invention the remote controller comprises means for generating the at least one control signal in the non-audio frequency band and means for superposing the at least one control signal on the at least one audio signal on the medium.

In other words, in this first embodiment, the remote controller not only encodes the command but also generates and superposes the control signal in which the command is encoded. As explained hereinafter, in a second embodiment the audio device generates and superposes the control signal.

If the medium includes a set of wires including a ground wire and at least one audio wire between the audio device and the controller, then the single audio wire or at least one of the audio wires, referred to herein as an audio/control wire, is advantageously also used as a control wire.

In other words, the remote controller of the present invention does not require any additional wire. In effect, one or more audio wires are used twice over, once for audio and again for remote control.

In one advantageous embodiment of the invention, the set of wires is connected to the audio device via a first jack with N connections, where N=X+1 where X is the number of audio wires and 1 represents the ground wire, at least one audio/control wire being included in the X audio wires, the first jack being adapted to cooperate with a second jack in the audio device.

It is important to note that the present invention can be implemented using standard jacks (i.e. jacks initially designed only for audio), which have the advantage of being cheaper and less fragile.

The remote controller preferably includes means for blocking the at least one control signal so that the audio accessory does not receive the at least one control signal.

In other words, the audio accessory receives only the at least one audio signal, only the audio device receiving the at least one control signal. This improves processing of the audio signal by the audio accessory by eliminating (or at least reducing) any noise due to the at least one control signal.

In a first preferred embodiment of the invention, the at least one control signal is a direct current signal the zero frequency of which is in the non-audio frequency band and the means for encoding the command comprise means for modifying and/or modulating at least one characteristic of the high-frequency current signal so that each command and/or combination of simultaneous commands corresponds to a particular set of characteristics of the high-frequency current signal.

In a second preferred embodiment of the invention, the at least one control signal is a high-frequency current signal the frequency or frequencies of which are in the non-audio frequency band and the means for encoding the command comprise means for modifying the frequency of frequencies of the high-frequency current signal so that each command corresponds to a predetermined different high frequency or a predetermined different combination of at least two high frequencies.

The invention also concerns an audio device adapted to be remote controlled by a remote controller and exchanging at least one audio signal with an audio accessory via a medium, the remote controller exchanging at least one control signal in which the command is encoded with the audio device, wherein the at least one control signal is in a non-audio frequency band separate from an audio frequency band in which the at least one audio signal is located and is superposed on the at least one audio signal on the medium and the audio device comprises means for decoding the command encoded in the at least one control signal.

The main advantage of the present invention is that it requires only one medium between the audio device and the remote controller for transmitting the audio signal(s) and the control signal(s). This in particular enables the use of standard jacks which are stronger and less costly than non-standard connectors.

In a second particular embodiment of the invention, the audio device includes means for generating the at least one control signal in the non-audio frequency band and means for superposing the at least one control signal on the at least one audio signal on the medium.

In the first embodiment referred to above the remote controller not only encodes the command but also generates and superposes the control signal in which the command is encoded.

The audio device advantageously includes means for detecting beforehand the presence of the encoded command in the at least one control signal.

In this way the other means (in particular the decoding means) need be activated only if a command is actually transmitted by the remote controller. Such means can therefore be “dormant” the rest of the time, to reduce the power consumption of the audio device. This is very important if the audio device has a limited battery life, which is typically the case with most personal stereos and mobile terminals.

The audio device preferably belongs to the group comprising mobile radio communication terminals and radio and/or cassette and/or compact disc personal stereos.

The audio accessory is advantageously a headset comprising at least one earpiece and/or at least one microphone.

In a first preferred embodiment of the invention the at least one control signal is a direct current signal the zero frequency of which is in the non-audio frequency band and the means for decoding the command comprise means for detecting the intensity of the direct current signal, each separate command corresponding to a predetermined separate intensity of the direct current signal.

In a second preferred embodiment of the invention the at least one control signal is a high-frequency current signal the frequency of which is or the frequencies of which are in the non-audio frequency band and the means for decoding the command include means for detecting characteristics of the high-frequency current signal, each command and/or combination of simultaneous commands corresponding to a particular set of characteristics of the high-frequency current signal.

Other features and advantages of the invention will become apparent on reading the following description of one preferred embodiment of the invention, which is given by way of illustrative and non-limiting example only and with reference to the accompanying drawings.

### BRIEF DESCRIPTION OF THE DRAWINGS

FIG. 1 is a simplified block diagram of one particular embodiment of a remote controller and of an audio device with its audio accessory in accordance with the present invention.

FIGS. 2 through 4 each show a different particular embodiment of the command decoder means included in the audio device from FIG. 1.

FIGS. 5 and 6 each show a different particular embodiment of the detector means in the command decoder means from each of FIGS. 2 to 4.

FIGS. 7 and 8 each show a different particular embodiment of the command encoder means included in the remote controller from FIG. 1.

### DETAILED DESCRIPTION OF THE PREFERRED EMBODIMENT

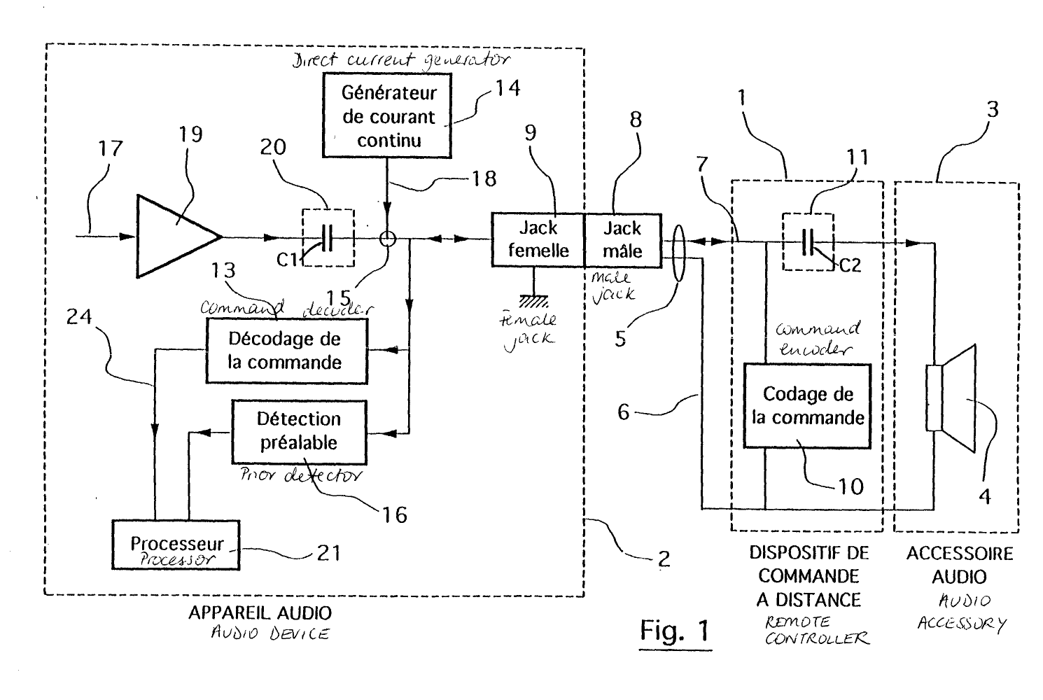

As shown in the FIG. 1 block diagram, what is of interest here is remote control by a remote controller 1 of an audio device 2 provided with an audio accessory 3.

Clearly there are many types of audio device, including personal stereos (radio and/or cassette and/or compact disc) and mobile radio communication terminals. Generally speaking, in the present context “audio device” means any device processing in particular:

at least one output audio signal, read from a storage medium (such as a cassette, a compact disc, a memory, etc) or received from the outside (for example by radio in the case of radio broadcasts and radio communication) and intended to be converted into sound waves by a loudspeaker (or earpiece); and/or

at least one input audio signal stemming from conversion of sound waves by a microphone and intended to be stored on a storage medium and/or transmitted to the exterior.

In the context of the present invention it is supposed that the audio device 2 is of the type that can cooperate with an audio accessory 3 in such a fashion as to relay to the audio accessory 3, if necessary, the audio signal/soundwave and/or the soundwave/audio signal conversion processes. Generally speaking, an audio accessory includes at least one earpiece (or loudspeaker) and/or at least one microphone. Clearly the audio device 2 can itself also comprise transducer means of this kind, namely earpiece(s) and/or microphone(s).

The audio device 2 and the audio accessory 3 conventionally exchange audio signals via an exchange medium 5. The exchange medium 5 comprises a set of wires, for example, grouped together in a cable and comprising a ground wire and one or more audio wires. The free end of the cable 5 is connected to a first jack 8 designed to cooperate with a second jack 9 in the audio device 2. One of the two lacks is of the female type (for example the second one 9) and the other of the male type (for example the first one 8).

In the particular embodiment described hereinafter the audio accessory 3 is a headset which, for simplicity, comprises only one transducer means, namely an earpiece 4. In this case the exchange medium 5 comprises only two wires, namely a ground wire 6 and an audio wire 7. It is therefore assumed hereinafter that the audio device 2 processes a single output audio signal 17 to be converted into soundwaves by the earpiece 4 of the audio accessory 3.

It is nevertheless clear that the present invention applies regardless of the number of audio wires, the skilled person being readily able to generalize the explanations given here to any other situation.

The remote controller 1 conventionally transmits one or more control signals to the audio device 2 to control its operation. The remote controller 1 must be readily accessible to the user to enable them to control the audio device 2, which is not easily accessible (for example because it is in a bag or in a pocket).

In accordance with the present invention, the existing exchange medium 5 (already used for exchanging audio signal(s) 17 between the audio device 2 and the audio accessory 3) is used again for exchanging control signals between the remote controller 1 and the audio device 2.

For this purpose the invention proposes a method of transmitting a command from the remote controller 1 to the audio device 2 comprising the following steps: generating the control signal(s) 18 in a non-audio frequency band separate from the audio frequency band in which the audio signal 17 is located, and superpositing the control signal(s) 18 and the audio signal 17 on the exchange medium 5.

In other words, the control signal(s) 18 are in a non-audio frequency band superposed on the audio signal 17 on the exchange medium 5.

For simplicity, the following description assumes that the remote controller 1 and the audio device 2 exchange only one control signal 18.

Accordingly, reverting to the example previously described hereinabove, this means that the single control signal 18 is also exchanged using the two wires 6, 7 of the exchange medium 5, namely the ground wire 6 and the audio wire 7. To indicate its two-fold function, the audio wire 7 may be referred to as the “audio/control wire”.

It is nevertheless clear that the present invention applies regardless of the number of control signals. It is entirely possible to superpose a plurality of control signals with the same audio signal on one pair of wires (ground wire, audio/control wire), for example. What is more, if there is a plurality of audio signals, each can be superposed with one or more control signals. In this second case there is then a plurality of pairs of wires (ground wire, audio/control wire).

One particular embodiment of the remote controller 1 and the audio device 2 will now be described in more detail.

By hypothesis, the audio signal 17 is an alternating current signal the frequencies of which are in the audio frequency band.

In this particular embodiment the control signal 18 is a direct current signal (the zero frequency of which is thus outside the audio band).

The remote controller 1 includes means 10 for encoding a command (one of a plurality of commands) in the direct current signal 18 (i.e. in the control signal). The encoder means 10 in turn comprise means for modifying the intensity of the direct current signal 18, for example according to the key pressed by the user. Each separate command corresponds to a predetermined separate intensity of the direct current signal.

FIGS. 7 and 8 each show a different particular embodiment of the control encoder means 10. In both embodiments a low-pass filter (Rf-Cf) smoothes variations in the direct current voltage to prevent the appearance of a signal in the audio band, i.e. background noise in the earpiece when a key is pressed.

In the first embodiment of the encoder means 10 (FIG. 7), each key (or switch) K1 to Kn is associated with a resistor R1 to Rn having a different value. Each time the user presses a key the corresponding resistance modifies the intensity of the direct current signal 18 (i.e. the value of the direct current voltage) after a set-up time due to the filter Rf-Cf.

In the second embodiment of the encoder means 10 (FIG. 8), the variation in the intensity of the direct current signal 18 when a key (or switch) K1 to Kn is pressed by the user is established by a programmable (current or voltage) generator 12.

Another embodiment of the encoder means 10, not shown, uses a complex resistor array connected to the keys.

The remote controller 1 optionally comprises first means 11 (for example a capacitor C2) for blocking the control signal 18 so that the audio accessory 3 does not receive it. Clearly the means 11 for blocking the control signal 18 are optional as the audio accessory 3 can be inherently non-responsive to the control signal 18.

The audio device 2 comprises means 13 for decoding the command encoded in the control signal 18. The decoder means 13 include means for detecting the intensity of the direct current signal. In this embodiment, after encoding by the encoder means 10 in the remote controller 1, each separate command corresponds to a predetermined separate intensity of the direct current signal 18. After decoding, the command 24 is sent to processor means 21 (for example a processor) that controls execution of the action corresponding to that command.

The audio device 2 further comprises:

an audio amplifier 19 for amplifying the audio signal 17;

second means 20 (for example a capacitor Cl) for blocking the control signal 18 so that the audio amplifier 19 cannot interfere with or be interfered with by the control signal 18 or the corresponding non-audio frequency band;

means 14 for generating a control signal 18 in the non-audio frequency band; this can simply be a resistor connected to a direct current power supply, or a current generator; and

means 15 for superposing the control signal 18 on the audio signal 17 on the exchange medium 5.

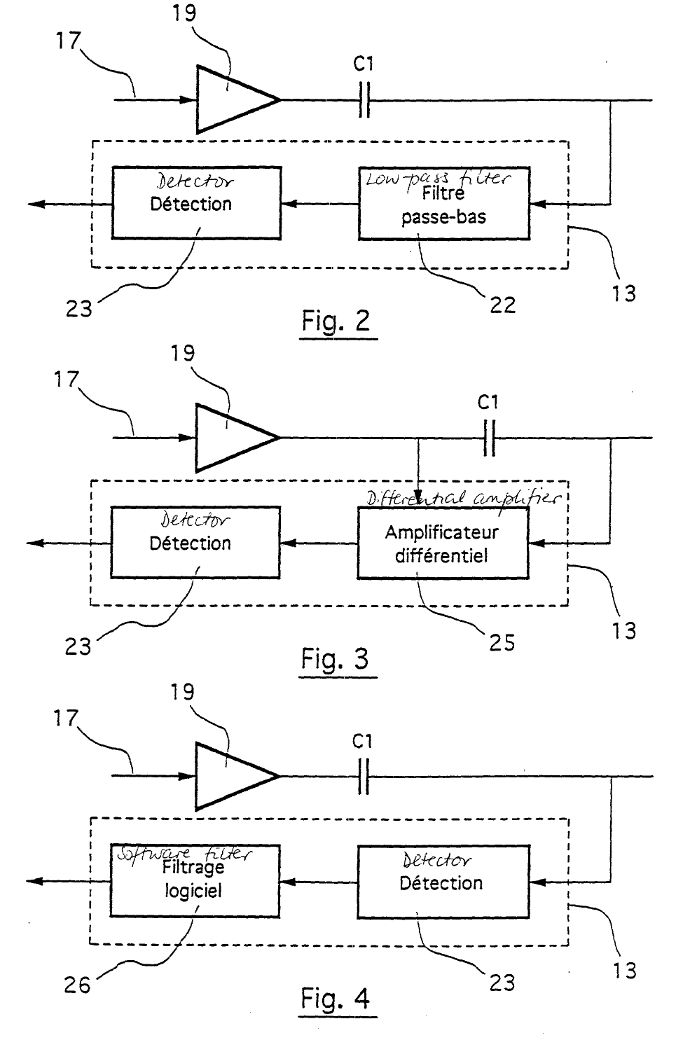

FIGS. 2, 3 and 4 each show a different particular embodiment of the decoder means 13.

In the first embodiment (FIG. 2) the decoder means 13 comprise:

a low-pass filter 22 which passes the direct current signal 18 (i.e. the control signal) and blocks the alternating current signal 17 (i.e. the audio signal); this is simply an R-C network, for example; and

means 23 for detecting the intensity of the direct current signal 18 (see the detailed description of both embodiments hereinafter). The detector means 23 determine which key the user pressed (i.e. the command encoded by the encoder means 10 of the remote controller 1). Each separate command corresponds to a predetermined separate intensity of the direct current signal 18.

The second embodiment (FIG. 3) of the decoder means 13 differs from the first embodiment (FIG. 2) in that the low-pass filter 22 is replaced by a differential amplifier 25.

The third embodiment (FIG. 4) of the decoder means 13 differs from the first embodiment (FIG. 2) in that the low-pass filter 22 is replaced by software filter means 26 downstream of the detector means 23 and used to correct the effects of the alternating current signal 17 on the detector means 23.

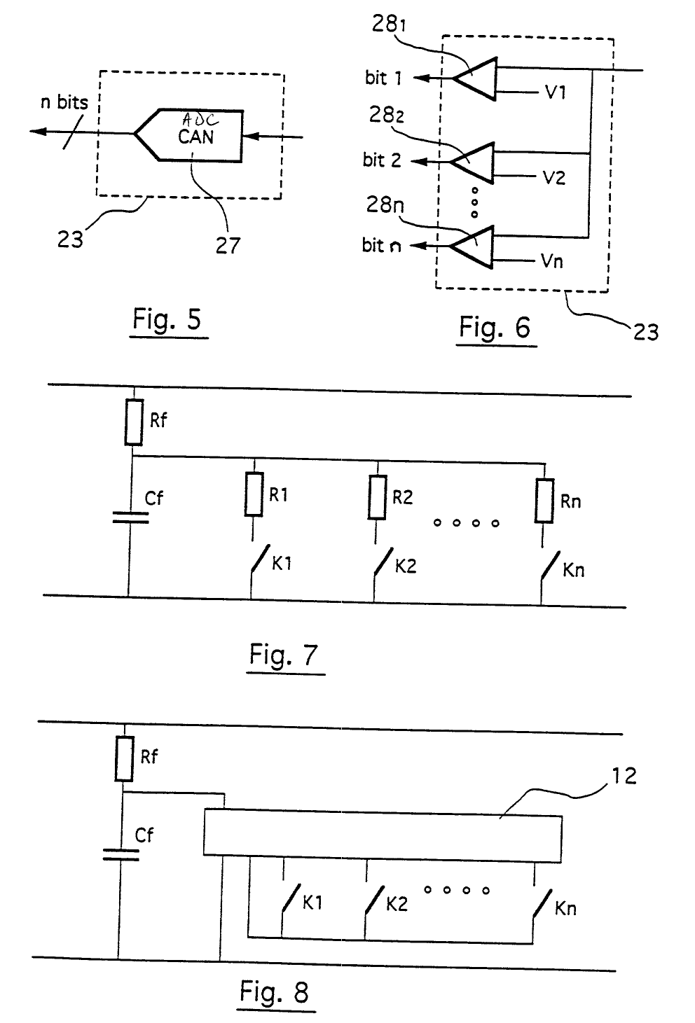

FIGS. 5 and 6 each show a different particular embodiment of the detector means 23 included in the decoder means 13.

In the first embodiment (FIG. 5) the means 23 for detecting the intensity of the direct current signal 18 comprise an analog/digital converter 27 for converting the direct current signal 18 to a digital form (for example on n bits) usable by the processor 21.

The second embodiment (FIG. 6) of the detector means 23 differs from the first embodiment (FIG. 5) in that the analog/digital converter 27 is replaced by a set of comparators 28₁ through 28ₙ for comparing the direct current signal 18 with a set of direct current voltage threshold values V1 to Vn.

The audio device 2 optionally further comprises means 16 for detecting beforehand the presence of an encoded command in the control signal 18. The means 16 can be based on a simple comparator.

Clearly many other embodiments of the invention can be envisaged.

In particular, the control signal 18 is not necessarily a direct current signal.

Thus in one variant of the invention the control signal 18 is a high-frequency current whose frequencies are within one or more non-audio frequency bands. In other words, they are not in the audio frequency band.

In a variant of the above kind the means for encoding the command comprise means for modifying and/or modulating one or more characteristics of the high-frequency current signal (i.e. the control signal), such modification and/or modulation being applied to the frequency and/or the amplitude and/or the phase of the high-frequency signal, or constituting a more complex modulation, so that each command and/or combination of simultaneous commands corresponds to a particular set of characteristics of the high-frequency current signal. What is more, the command decoder means comprise means for detecting characteristics of the high-frequency current signal, each command and/or combination of simultaneous commands corresponding to a particular set of characteristics of the high-frequency current signal.

Placing the means 14 for generating the control signal 18 and the means 15 for superposing the control signal 18 on the audio signal 17 on the exchange medium 5 in the remote controller 1 (rather than in the audio device 2) can be considered without departing from the scope of the invention.

There is claimed:

1. A method of transmitting a command from a remote controller to an audio device exchanging at least one audio signal with an audio accessory via a medium, said remote controller exchanging at least one control signal in which said command is encoded with said audio device, said method comprising the following steps: generating said at least one control signal in a non-audio frequency band separate from an audio frequency band in which said at least one audio signal is located, and superposing said at least one control signal and said at least one audio signal on said medium.

2. A remote controller for an audio device exchanging at least one audio signal with an audio accessory via a medium, said remote controller exchanging at least one control signal in which said command is encoded with said audio device, wherein said at least one control signal is in a non-audio frequency band separate from an audio frequency band in which said at least one audio signal is located and superposed on said at least one audio signal on said medium and said remote controller comprises means for encoding said command in said at least one control signal.

3. The remote controller claimed in claim 2 comprising means for generating said at least one control signal in said non-audio frequency band and means for superposing said at least one control signal on said at least one audio signal on said medium.

4. The remote controller claimed in claim 2 wherein said medium comprises a set of wires comprising a ground wire and at least one audio wire between said audio device and said control device and said audio wire or at least one of said audio wires constitutes an audio/control wire used also as a control wire.

5. The remote controller claimed in claim 4 wherein said set of wires is connected to said audio device via a first jack with N connections, where N=X+1 where X is the number of audio wires and 1 represents said ground wire, at least one audio/control wire being included in said X audio wires, said first jack being adapted to cooperate with a second jack in said audio device.

6. The remote controller claimed in claim 2 comprising means for blocking said at least one control signal so that said audio accessory does not receive said at least one control signal.

7. The remote controller claimed in claim 2 wherein, said at least one audio signal being an alternating current signal the frequency or frequencies of which are in said audio frequency band, said at least one control signal is a direct current signal the zero frequency of which is in said non-audio frequency band and said means for encoding said command comprise means for modifying the intensity of said direct current signal so that each separate command corresponds to a predetermined separate intensity of said direct current signal.

8. The remote controller claimed in claim 2 wherein, said at least one audio signal being an alternating current signal the frequency or frequencies of which are in said audio frequency band, said at least one control signal is a high-frequency current signal the frequency or frequencies of which are in said non-audio frequency band and said means for encoding said command comprise means for modifying and/or modulating at least one characteristic of said high-frequency current signal so that each command and/or combination of simultaneous commands corresponds to a particular set of characteristics of said high-frequency current signal.

9. An audio device adapted to be remote controlled by a remote controller and exchanging at least one audio signal with an audio accessory via a medium, said remote controller exchanging at least one control signal in which said command is encoded with said audio device, wherein said at least one control signal is in a non-audio frequency band separate from an audio frequency band in which said at least one audio signal is located and is superposed on said at least one audio signal on said medium and said audio device comprises means for decoding said command encoded in said at least one control signal.

10. The audio device claimed in claim 9 comprising means for generating said at least one control signal in said non-audio frequency band and means for superposing said at least one control signal on said at least one audio signal on said medium.

11. The audio device claimed in claim 9 comprising means for detecting beforehand the presence of said encoded command in said at least one control signal.

12. The audio device claimed in claim 9 selected from the group comprising mobile radio communication terminals and radio and/or cassette and/or compact disc personal stereos.

13. The audio device claimed in claim 9 wherein said audio accessory is a headset comprising at least one earpiece and/or at least one microphone.

14. The audio device claimed in claim 9 wherein, said audio signal being an alternating current signal the frequency or frequencies of which are in said audio frequency band, said at least one control signal is a direct current signal the zero frequency of which is in said non-audio frequency band and said means for decoding said command comprise means for detecting the intensity of said direct current signal, each separate command corresponding to a predetermined separate intensity of said direct current signal.

15. The audio device claimed in claim 9 wherein, said at least one audio signal being an alternating current signal the frequency or frequencies of which are in said audio frequency band, said at least one control signal is a high-frequency current signal the frequency or frequencies of which are in said non-audio frequency band and said means for decoding said command comprise means for detecting characteristics of said high-frequency current signal, each command and/or combination of simultaneous commands corresponding to a particular set of characteristics of said high-frequency current signal.
